(19) United States
(12) Patent Application Publication
(10) Pub. No.: US 2007/0176993 A1
(43) Pub. Date: Aug. 2, 2007

(54) Active ray curable ink-jet ink composition, method for forming image, and ink-jet recording apparatus

(75) Inventor: Nobumasa Sasa, Sayama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/656,135

(22) Filed: Jan. 22, 2007

(30) Foreign Application Priority Data
Feb. 2, 2006 (JP) JP2006-025278

(51) Int. Cl. B41J 2/01

(52) U.S. Cl. 347/102

(57) ABSTRACT

An active ray curable ink-jet ink composition comprising: (a) a cationic polymerizable compound, (b) a cationic photopolymerization initiator, and (c) an alkyl modified or an alkyl aralkyl modified silicone oil.

This application is based on Japanese Patent Application No. 2006-025278 filed on Feb. 2, 2006, in Japanese Patent Office, the entire content of which is hereby incorporated by reference.

### FIELD OF THE INVENTION

The present invention relates to an active ray curable ink-jet ink composition containing a cationic polymerizable compound, a method for forming an image and an ink-jet recording apparatus using the same.

### BACKGROUND OF THE INVENTION

In recent years, an ink-jet recording method has been applied in a variety of fields such as photography, various types of printing, marking and special printing of such as production of color filters, because of its capability of forming an image simply and at low cost. In particular, it is now also possible to obtain image quality comparable to silver salt photography by utilizing a recording apparatus which ejects and controls micro dots, and by using exclusive paper, in which a coloring capability of colorants and surface glossiness have been significantly improved. The recent image quality improvement has been achieved largely by the combination of recording material, ink and exclusive paper.

However, an ink-jet system which requires exclusive paper has problems of limitation of the recording medium and increased cost of that recording medium. Therefore, much effort has been made to achieve recording on a medium, onto which the image is finally transferred, different from that used for exclusive paper by an ink-jet method. Specifically, a phase transition ink-jet method which utilizes wax ink, being solid at room temperature, a solvent type ink-jet method which utilizes ink composed primarily of a rapid-drying organic solvent, and an active ray curable ink-jet method in which an ink image is cross-linked by irradiation of active energy rays (radiation) such as ultraviolet rays (UV light) after recording.

Among these systems, an ultraviolet curing type ink-jet method has been noted with respect to relatively low odor compared to a solvent type ink-jet method, rapid-drying and capability of recording on a recording medium without ink absorptive capability, and various ultraviolet curable ink-jet inks corresponding thereto have been disclosed.

However, even when these inks were employed, it was impossible to form a high definition image on various kinds of recording media due to unstable ink ejection and a broad rang of the ink dot diameter after ink deposition, depending on the kinds of recording materials and printing environment.

Specifically, in an ultraviolet curable type ink-jet ink, there is a problem that the ink tends to be influenced by the water content (humidity) at the molecular level although the ink employing a cationic polymerizable compound does not receive any oxygen inhibitory activity.

Conventionally, an active ray curable ink-jet ink employing a modified silicone oil has been known (please refer for example to Patent Document 1). However, even when this invention was re-tested, it was not compatible in ink ejection stability and high definition image formation under varying printing environments. Further, in the combinations with a radical polymerizable type curable composition, although there is a description in the specification that a polyether modified silicone oil exhibiting the specified HLB (being a hydrophile-lipophile balance) is superior to an alkyl modified silicone oil of this invention, there is no description of the combinations with a cationic polymerizable type curable composition of this invention.

[Patent Document 1] Unexamined Japanese Patent Application Publication No. (hereinafter, referred to as JP-A) 2003-147233

### SUMMARY OF THE INVENTION

This invention has been achieved in view of the above-described problems, and an object of this invention is to provide an active ray curable ink-jet ink composition which exhibits excellent ink ejection stability, text character quality, and no staining generation, and also enables highly stable high definition image recording, under varying printing environments, and provides a method for image forming and an ink-jet recording apparatus using the same.

### BRIEF DESCRIPTION OF THE DRAWINGS

The above-described object of this invention was achieved by the following constitutions.

Item 1. An active ray curable ink-jet ink composition comprising:

(a) a cationic polymerizable compound,

(b) a cationic photopolymerization initiator, and

(c) an alkyl modified or an alkyl aralkyl modified silicone oil.

Item 2. The active ray curable ink-jet ink composition of Item 1 above, wherein the cationic polymerizable compound is (i) a compound having an oxetane ring, or (ii) an epoxy compound.

Item 3. The active ray curable ink-jet ink composition of Item 1 or 2 above, an amount of the alkyl modified or the alkyl aralkyl modified silicone oil is from 0.001-10 weight % based on the total weight of the ink-jet ink composition.

Item 4. The active ray curable ink-jet ink composition of any one of Items 1-3 above, wherein the ink-jet ink composition includes at least one pigment.

Item 5. The active ray curable ink-jet ink composition of any one of Items 1-4 above, wherein a surface tension of the ink-jet ink composition at 25° C. is 25-35 mN/m.

Item 6. The active ray curable ink-jet ink composition of any one of Items 1-5, wherein the ink-jet ink composition has a viscosity of 7-50 mPa·s.

Item 7. A method for forming an image comprising the steps of:

(a) ejecting an active ray curable ink-jet ink composition of any one of Items 1-5 onto a recording material, and

(b) irradiating active rays onto the ejected ink-jet ink composition to form an image,

wherein the active rays are irradiated during 0.001-2.0 sec. after the active ray curable ink-jet ink composition is deposited.

Item 8. An ink-jet recording apparatus employed for the method of Item 7 above, wherein an active ray curable ink-jet ink composition is ejected from a recording head after the active ray curable ink-jet ink composition and the recording head are heated to 35-100° C.

Item 9. The ink-jet recording apparatus employed for the method of Item 8 above, wherein a nozzle surface of the recording head from which the active ray curable ink-jet ink composition is ejected is made of metal.

According to this invention, it is possible to provide an active ray curable ink-jet ink composition which exhibits excellent ink ejection stability, high text character quality, and no stain generation, also enables highly stable high definition image recording, under varying printing environments, and provides a method for image formation and an ink-jet recording apparatus using the same.

### BRIEF DESCRIPTION OF THE DRAWINGS

Embodiments will now be described, by way of example only, with reference to the accompanying drawings which are meant to be exemplary, not limiting, and wherein like are elements numbered alike in the several figures, in which:

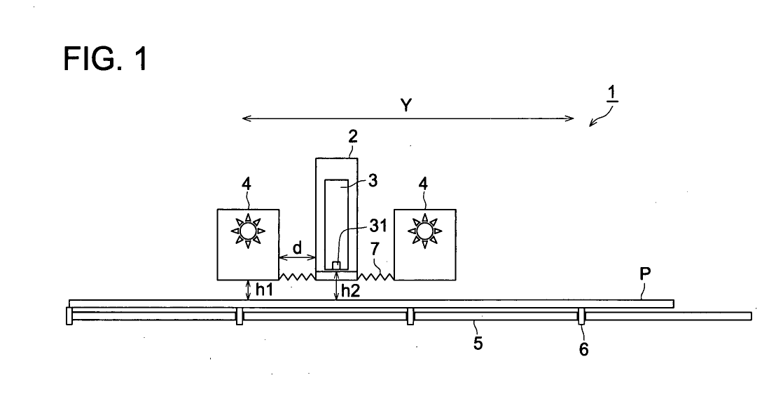

FIG. 1 is a front view showing a constitution of the chief parts of the recording apparatus of this invention.

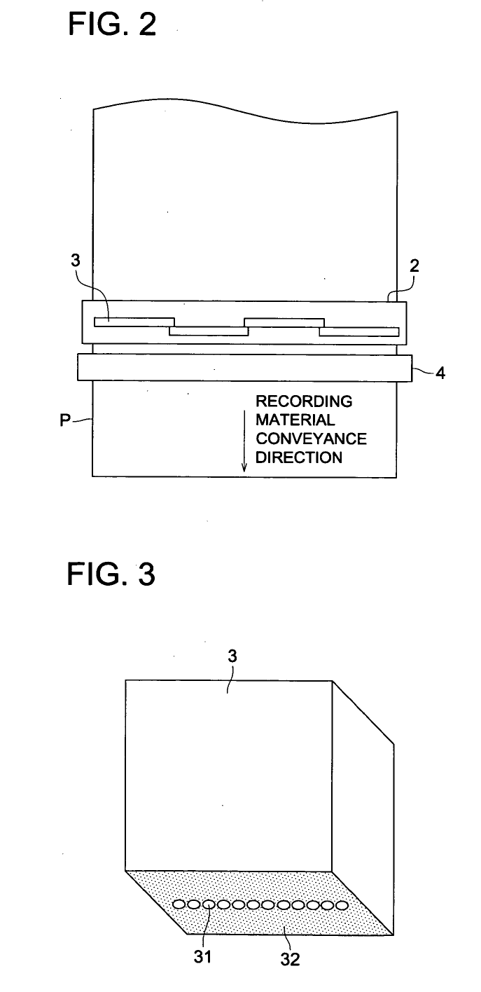

FIG. 2 is a top view showing an example of the other constitutions of the chief parts of the ink-jet recording apparatus.

FIG. 3 is a Figure showing a nozzle surface of the ink-jet recording head of the ink-jet recording apparatus of this invention.

### PREFERABLE EMBODIMENTS OF THIS INVENTION

It should be understood that no single element of any of the embodiments described herein is essential, and that it is within the contemplation of the invention that one or more elements (or method steps) of one or more embodiments of the invention as described herein may be omitted or their functionality may be combined with that of other elements as a general matter of design choice.

The present invention will now be described in more detail below.

The alkyl modified silicone oil of this invention has as part of its structure which contains [OSi(CH₃)(R¹)] and/or [OSi(R¹) (R²)] as a repeating unit. Here, R¹ and R² are independently an alkyl group having more than two carbon atoms, a cycloalkyl group having more than three carbon atoms, or an alkyl substituted cycloalkyl group having more than four carbon atoms. The alkyl of an alkyl group may be a straight-chain or a side-chain alkyl. As examples of R¹ and R², listed are an ethyl group, a propyl group, a butyl group, a pentyl group, a hexyl group, an octyl group, a nonyl group, a decyl group, a dodecyl group, a tetradecyl group, a hexadecyl group, an octadecyl group, a cyclopentyl group, a cyclohexyl group, a cycloheptyl, and a 2-methyl cyclohexyl group. Further, the above alkyl modified silicone oil of this invention may contain [OSi(CH₃)₂] in small quantities as a repeating unit, and may contain a small amount of repeating units provided with substituent groups, in which above R¹ or R² has one or more than two unsaturated bonds.

Specific examples of the alkyl modified silicone oil include, for example, “TSF4420” being a trade name and produced by GE Toshiba Silicone Co., Ltd., “XF42-A3161” being a trade name and produced by GE Toshiba Silicone Co., Ltd., “TSF4421” being a trade name and produced by GE Toshiba Silicone Co., Ltd., “KF910” being a trade name and produced by Shin-Etsu Chemical Co., Ltd., “KF412” being a trade name and produced by Shin-Etsu Chemical Co., Ltd., “KF413” being a trade name and produced by Shin-Etsu Chemical Co., Ltd., “KF414” being a trade name and produced by Shin-Etsu Chemical Co., Ltd., “SH200” being a trade name and produced by Dow Corning Toray Silicone Co., Ltd., “SH203” being a trade name and produced by Dow Corning Toray Silicone Co., Ltd., “SH230” being a trade name and produced by Dow Corning Toray Silicone Co., Ltd., “SF8416” being a trade name and produced by Dow Corning Toray Silicone Co., Ltd., “EFKA3236” being a trade name and produced by Efka Additives, “EFKA3239” being a trade name and produced by Efka Additives, and “EFKA3522” being a trade name and produced by Efka Additives.

Further, the alkyl aralkyl modified silicone oil of this invention has a structure which contains [OSi(CH₃)(R³)] and/or [OSi(R³) (R⁴)] as a repeating unit. Here, R³ and R⁴ are independently chosen from a phenyl group, a diphenyl group, a naphthyl group, a tolyl group, an alkylphenyl group, a dialkylphenyl group, an alkylnaphthyl group, or a dialkylnaphthyl group. The alkyl group, as a substituent group, usually has 1-12 carbon atoms, and may be a straight-chain or a side-chain alkyl group. Further, the above-mentioned alkyl aralkyl modified silicone oil of this invention may contain at least one of [OSi(CH₃)₂], above exemplified [OSi(CH₃)(R¹)] and [OSi(R¹)(R²)] in a small amount as repetition units, and may contain a small amount of a repeating unit provided with a substituent group which has at least one unsaturated bond.

Specific examples of the alkyl aralkyl modified silicone oil include “TSF4420” being a product name and produced by GE Toshiba Silicone Co., Ltd., “KF410” being a product name and produced by Shin-Etsu Chemical Co., Ltd., “BYK322” being a product name and produced by BYK-Chemie Japan K.K., and “BYK323” being a product name and also produced by BYK-Chemie Japan K.K. The added amount of the silicone oil is preferably 0.001-10 weight % based on the total weight of the ink.

The compound having an oxetane ring of this invention is described below.

The oxetane compound, as a cationic polymerizable compound employable in this invention, is a compound which has at least one oxetane ring in the molecule. Specifically, 3-ethyl-3-hydroxymethyl oxetane (such as OXT-101, being a product name and produced by Toagosei Co., Ltd.), 1,4-bis[(3-ethyl-3-oxetanyl)methoxy methyl]benzene (such as OXT-121), 3-ethyl-3-(phenoxy methyl)oxetane (such as OXT-211), di(1-ethyl-3-oxetanyl)methyl ether (such as OXT-221), 3-ethyl-3-(2-ethylhexyloxy methyl)oxetane (such as OXT-212) are preferably employed. In particular, 3-ethyl-3-hydroxymethyl oxetane, 3-ethyl-3-(phenoxy methyl)oxetane, and di(1-ethyl-3-oxetanyl)methyl ether, are preferable. These may be employed singly or in combination of two or more kinds.

The oxetane compound of this invention is typically incorporated at 30-95 weight %, and preferably 50-80 weight % based on the total weight of the active ray curable ink-jet ink composition.

Examples of epoxy compounds of this invention include the following aromatic series epoxides, cyclane epoxides, and aliphatic series epoxides.

A preferable aromatic epoxide is a di- or a polyglycidyl ether produced by the reaction of polyhydric phenol which has at least one aromatic nucleus, or its alkylene oxide adduct, and epichlorohydrin, and listed examples are di- or polyglycidyl ether of bisphenol A or its alkylene oxide adduct, di- or polyglycidyl ether of hydrogenated bisphenol A or its alkylene oxide adduct, and novolak type epoxy resin. Ethyleneoxide and propylene oxide may also be cited as alkylene oxides.

An alicyclic epoxide is preferably a compound which contains a cyclohexene oxide or a cyclopentene oxide, which is obtained by epoxydation of the compound having at least one cycloalkane ring such as cyclohexene or a cyclopentene ring, employing an appropriate oxidizing agent, such as hydrogen peroxide or a peracide.

Examples of preferable alicyclic epoxides include a di- or polyglycidyl ether of an aliphatic polyhydric alcohol or its alkylene oxide adduct. As representative examples, listed are, for example, a diglycidyl ether of alkylene glycol, such as diglycidyl ether of ethylene glycol, diglycidyl ether of propylene glycol, or diglycidyl ether of 1,6-hexanediol; a polyglycidyl ether of polyhydric alcohol, such as a di- or triglycidyl ether of glycerin or its alkylene oxide adduct; and diglycidyl ether of polyalkylene glycol, such as a diglycidyl ether of polyethylene glycole or its alkylene oxide adduct, and a diglycidyl ether of polypropylene glycol or its alkylene oxide adduct. Ethylene oxide and propylene oxide may also be cited as alkylene oxides here.

When quick-curing of these epoxides is taken into consideration, aromatic epoxides and alicyclic epoxides are preferable, and alicyclic epoxides are specifically preferable.

In this invention, specifically preferable alicyclic epoxides are described, for example, in JP-A Nos. 2004-315778 and 2005-28632.

Exemplified compounds are shown below.

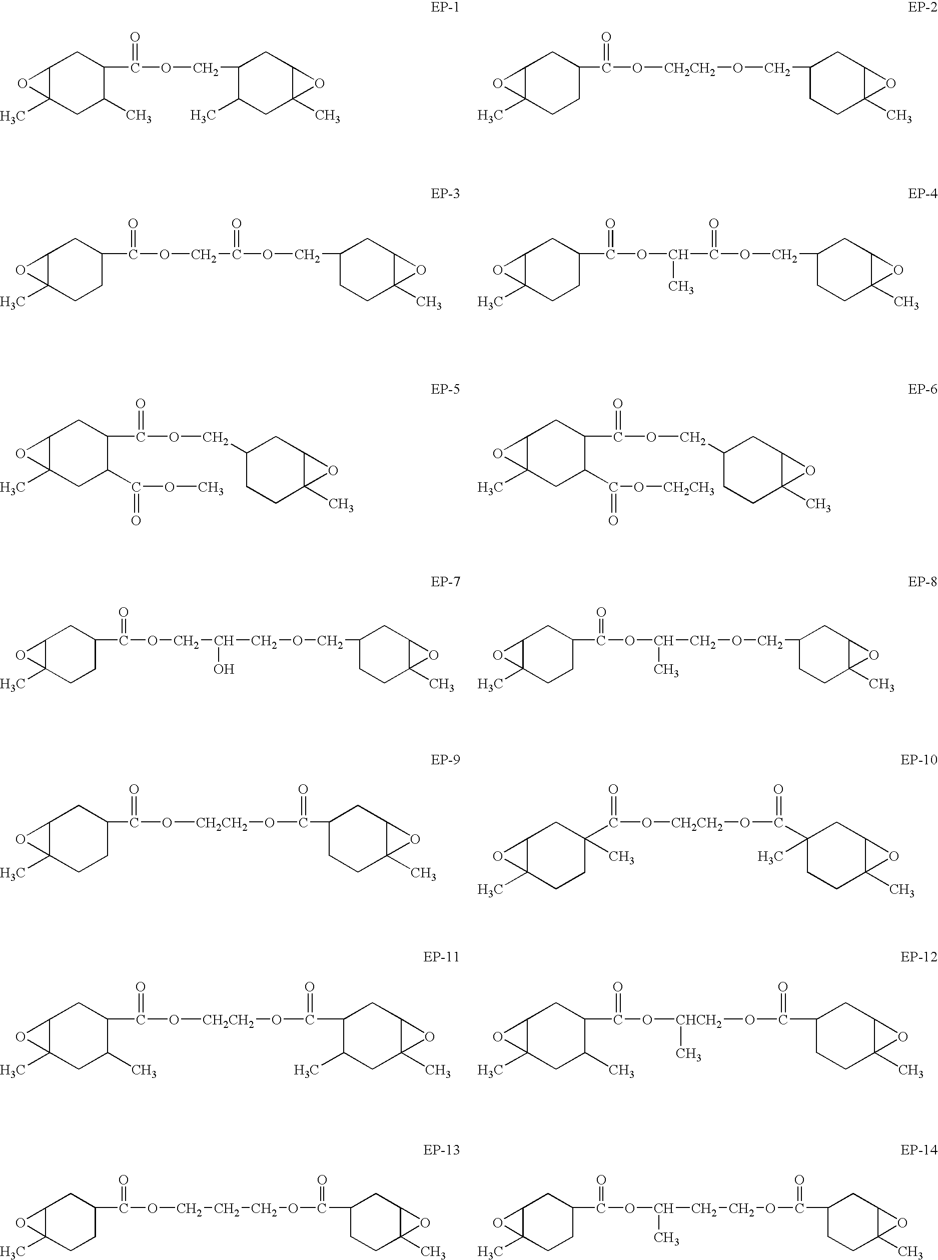

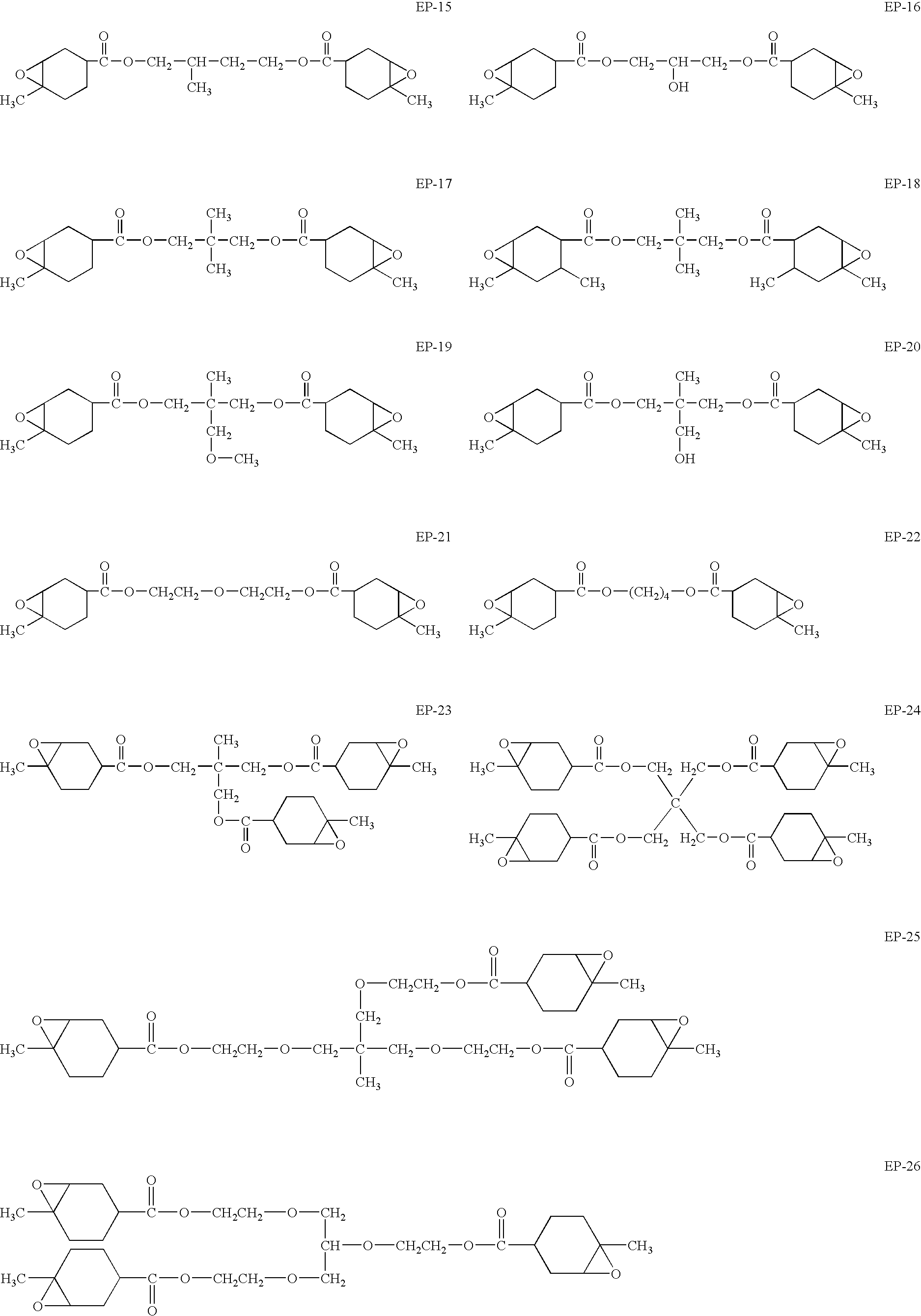

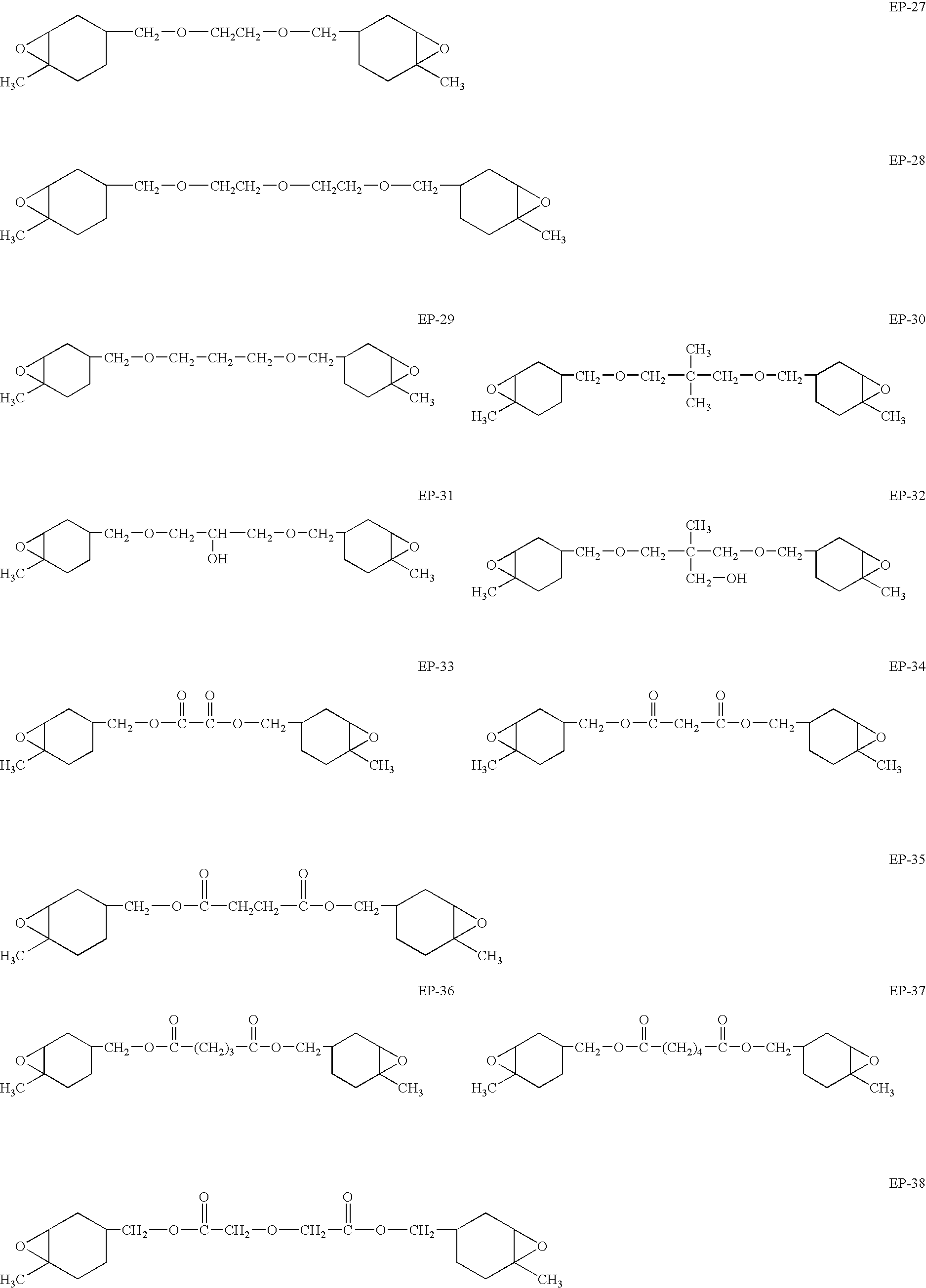

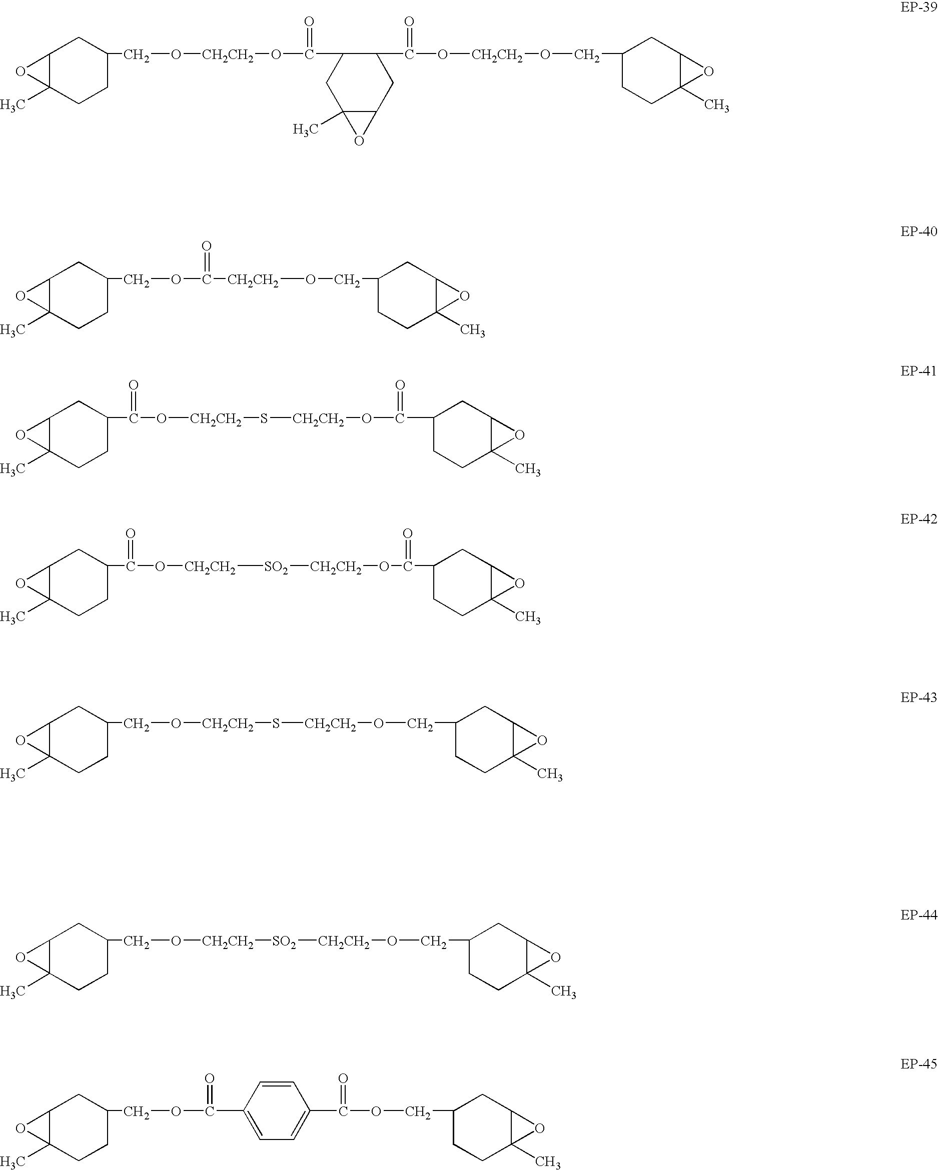

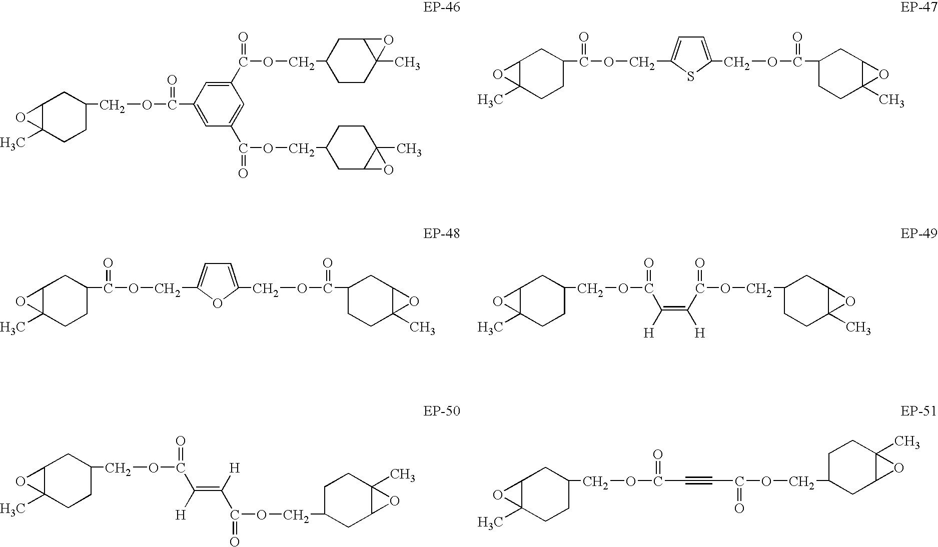

In this invention, one kind of the above epoxide may be employed alone, and may also be employed in combination of appropriate two or more kinds.

These epoxides may be incorporated in an amount of 0-50 weight %, and preferably 0-30 weight % based on the total weight of the active ray curable ink-jet ink composition of this invention.

In this invention, a vinyl ether compound may also be employed in combination as a cationic polymerizable compound. For example, listed are a di- or a trivinyl ether compound, such as ethylene glycol divinylether, ethylene glycol monovinyl ether, diethylene glycol divinylether, triethylene glycol mono-vinyl ether, triethylene glycol divinyl ether, propylene glycol divinyl ether, dipropylene glycol divinyl ether, butanediol divinyl ether, hexane diol divinyl ether, cyclohexanedimethanol divinyl ether, hydroxyethyl monovinyl ether, hydroxy nonyl monovinyl ether, and trimethylolpropane trivinyl ether; and a monovinyl ether compounds, such as, ethyl vinyl ether, n-butyl vinyl ether, isobutyl vinyl ether, Octadecyl vinyl ether, cyclohexyl vinyl ether, hydroxy butyl vinyl ether, 2-ethylhexyl vinyl ether, cyclohexanedimethanol mono-vinyl ether, n-propyl vinyl ether, isopropyl vinyl ether, isopropenyl ether o-propylene carbonate, dodecyl vinyl ether, diethylene glycol mono-vinyl ether, and octadecyl vinyl ether.

In this invention, it is preferable that a cationic photopolymerization initiator is an onium salt type photoinduced acid generating agent which does not generate benzene by irradiation of active rays. Specifically, an onium salt type photoinduced acid generating agent is at least one kind of sulfonium salts represented by following Formulas (1)-(4).

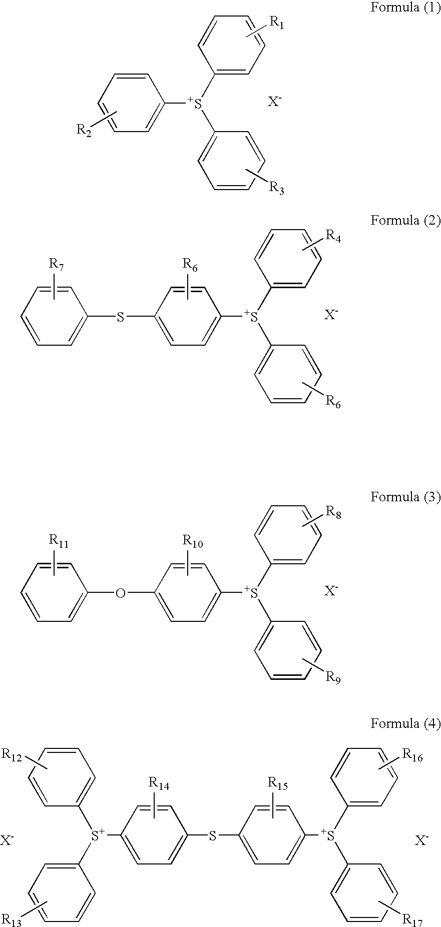

In Formulas, R₁-R₁₇ are each a hydrogen atom or a substituent group, but R₁-R₃ are not a hydrogen atom at the same time, R₈-R₁₁ are not a hydrogen atom at the same time, and R₁₂-R₁₇ are not a hydrogen atom at the same time. X⁻ is a non-nucleophilic anionic residue.

Further, a sulfonium salt selected from above Formulas (1)-(4) is more specifically at least one selected from following Formulas (5)-(13).

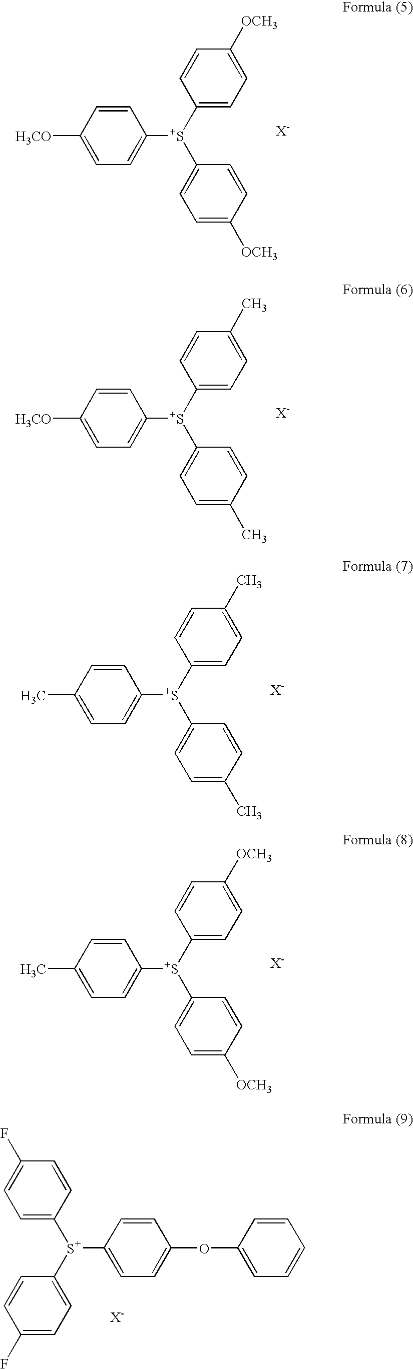

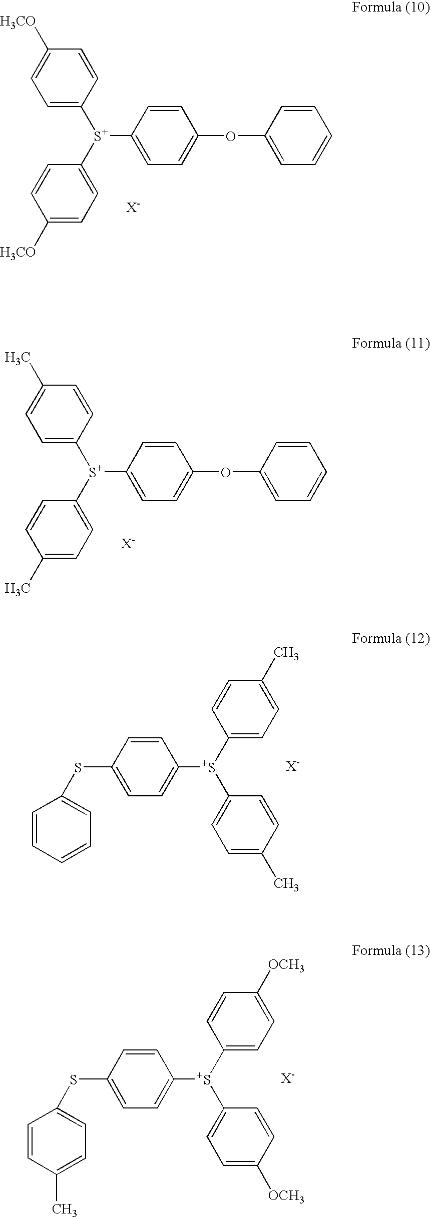

In Formulas, X⁻ is a non-nucleophilic anionic residue.

In this invention, the expression “does not generate benzene by irradiation of active rays” means that substantially it does not generate benzene, and specifically, it means that when the ink containing an onium salt (being a photoinduced acid generating agent) in an amount of 5 weight % in the ink composition is employed, an image of about 100 m² is printed at thickness of 15 μm, and the ink layer surface is irradiated with active rays in an amount that the photoinduced acid generating agent is sufficiently dissolved under the condition of remaining the ink layer at 30° C., the amount of generated benzene is ultralow volume of less than 5 μg or zero. A sulfonium salt or an iodonium salt is preferable as the onium salt, and if it has a substituent group on a benzene ring bonding to S⁺ or I⁺, it satisfies the above requirements. A sulfonium salt compound represented by above Formulas (1)-(4) is preferred, and when one having a substituent group on a benzene ring bonding to S⁺, it satisfies the above requirements.

In above Formulas (1)-(4), R₁-R₁₇ are each a hydrogen atom or a substituent group, but R₁-R₃ are not simultaneously hydrogen atoms, R₄-R₇ are not simultaneously hydrogen atoms, R₈-R₁₁ are not simultaneously hydrogen atoms, and R₁₂-R₁₇ are not simultaneously hydrogen atoms.

Examples of the substituents groups represented by R₁-R₁₇ preferably include an alkyl group such as a methyl group, an ethyl group, a propyl group, an isopropyl group, a butyl group, an isobutyl group, a t-butyl group, a pentyl group, or a hexyl group; an alkoxy group such as a methoxy group, an ethoxy group, a propoxy group, an isopropyl group, a butoxy group, a hexyloxy group, a decyloxy group, or a dodecyloxy group; a carbonyl group such as an acetoxy group, a propionyloxy group, a decylcarbonyloxy group, a dodecylcarbonyloxy group, a methoxycarbonyl group, an ethoxycarbonyl group or a benzoyloxy group; a phenylthio group; a halogen atom such as fluorine, chlorine, bromine or iodine; a cyano group; a nitro group; and a hydroxyl group.

X⁻ is a non-nucleophilic anionic residue, listed are, for example, a halogen ion such as F⁻, Cl⁻, Br⁻ or I⁻; B(C₆F₅)₄⁻, R₁₈COO⁻, R₁₉SO₃⁻, SbF₆⁻, AsF₆⁻, PF₆⁻, and BF₄⁻, in which R₁₈ and R₁₉ are independently an alkyl group such as a methyl group, an ethyl group, a propyl group or a butyl group; a halogen atom such as fluorine, chlorine, bromine or iodine; an alkyl group or a phenyl group, which may be substituted with an alkoxy group such as a nitro group, a cyano group, a methoxy group or an ethoxy group. Of these, B(C₆F₅)₄⁻ and PF₆⁻ are preferred in regard to operation safety.

The above described compounds are easily synthesized using commonly known methods, for example, in the same manner as the method to prepare a photoinduced acid generating agent, described in The Chemical Society of Japan, Vol. 71, No. 11 (1998) or in “Organic Materials for Imaging” edited by The Japanese Research Association for Organic Electronics Materials (1993), published by Bun-Shin Publishing.

In this invention, it is specifically preferable that any one of the sulfonium salts represented by Formulas (1)-(4) is one of the sulfonium salts represented by following Formulas (5)-(13). X⁻ is a non-nucleophilic anionic residue and the same as the above description.

AS the exemplified compounds including iodonium salts, listed are the following compounds other than the compounds of X⁻═PF₆⁻ in above Formulas (5)-(13).

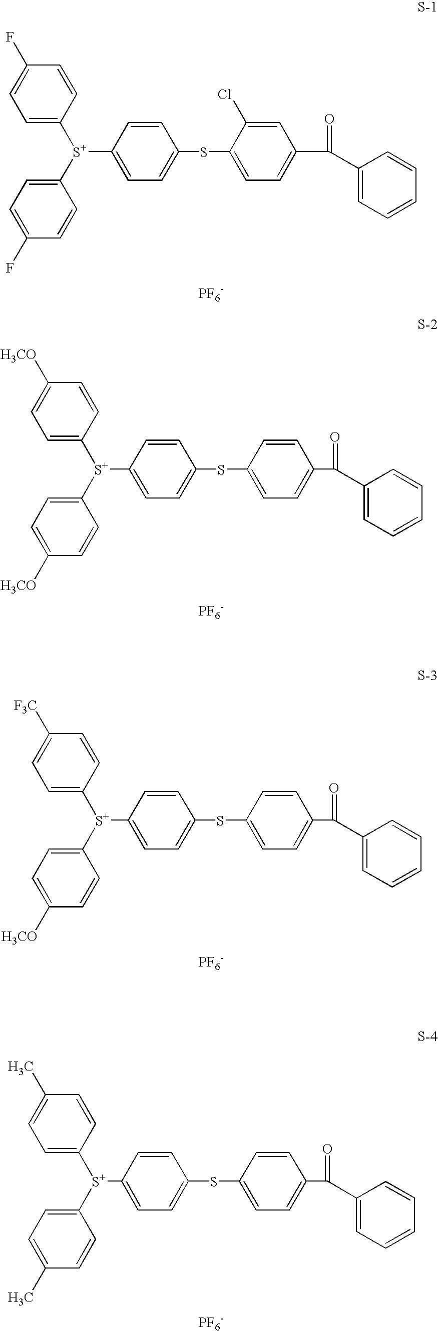

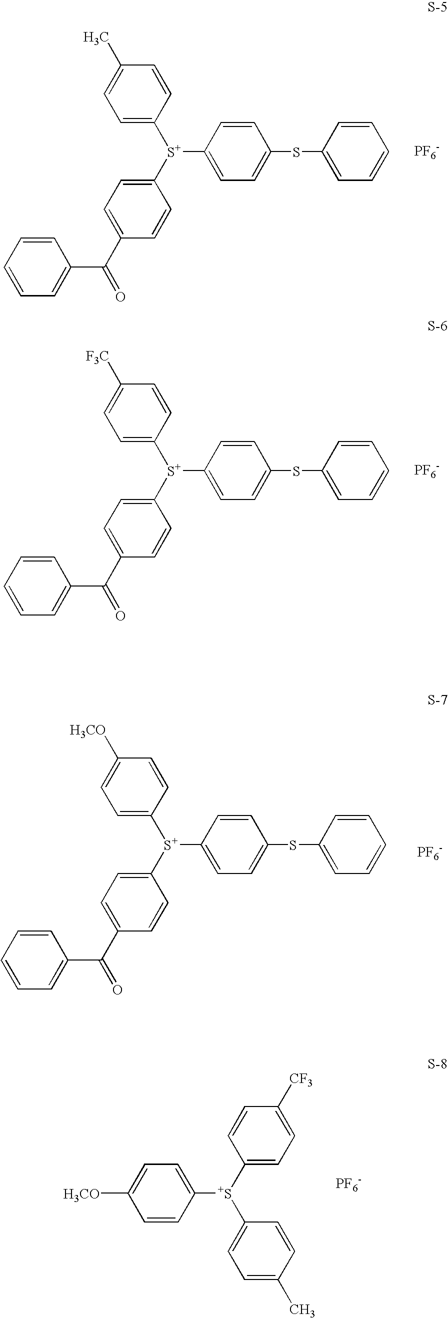

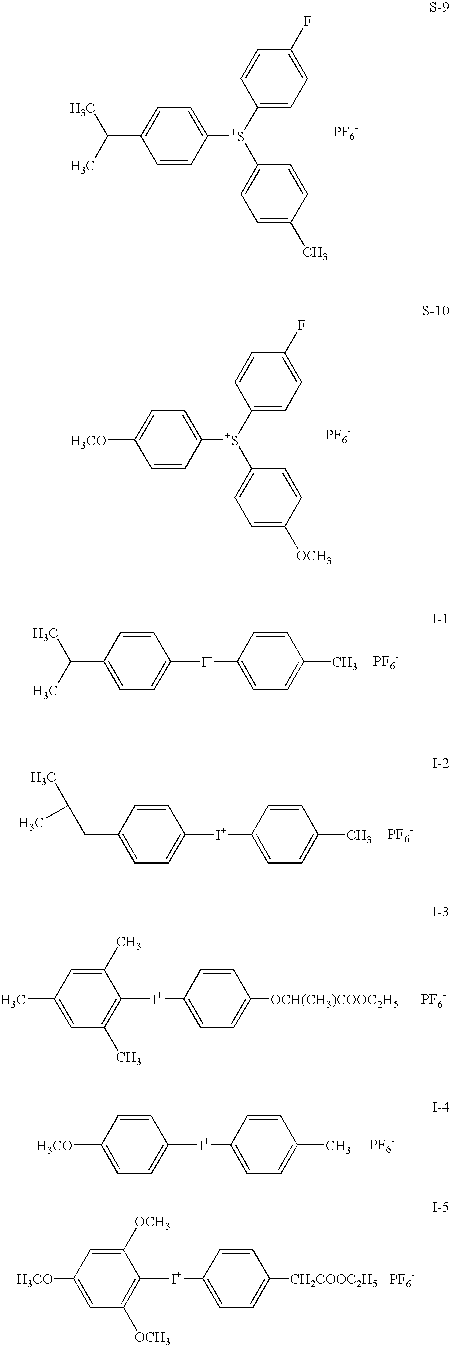

The active ray curable ink-jet ink composition of this invention contains a pigment as a colorant. The preferably employable pigments in this invention are listed below.

C. I. Pigment Yellow-1, 3, 12, 13, 14, 42, 74, 81, 83, 87, 93, 95, 109, 120, 128, 138, 139, 151, 166, 180, and 185,

C. I. Pigment Orange-16, 36, and 38,

C. I. Pigment Red-5, 22, 34, 48:1, 48:2, 48:4, 49:1, 53:1, 57:1, 63:1, 101, 122, 144, 146, 177, and 185,

C. I. Pigment Violet-19, and 23,

C. I. Pigment Blue-15:1, 15:3, 15:4, 18, 60, 27, and 29,

C. I. Pigment Green-7, and 36,

C. I. Pigment White-6, 18, and 21,

C. I. Pigment Black-7,

To disperse the above pigments, employable are, for example, a ball mill, a sand mill, an attritor mill, a roll mill, an agitator, a Henschel mixer, a colloidal mixer, a ultrasonic homogenizer, a pearl mill, a wet jet mill and a paint shaker. The dispersion medium is preferably a cationic polymerizable compound, and it is preferable to select one exhibiting lowest viscosity from the viewpoint of dispersibility.

In dispersion of pigments, it is preferable to bring an average particle diameter to be 0.08-0.5 μm, and selection of pigment, dispersing agent, and dispersion medium, dispersion conditions, and filtration condition are appropriately set up so that the maximum particle diameter of the pigment becomes 0.3-10 μm, and preferably 0.3-3 μm. By this particle diameter control, it is possible to reduce clogging of the head nozzles and to maintain stable storage of the ink, as well as its transparency and curing sensitivity.

The content of a pigment is preferably 1-10 weight % based on the total weight of the ink composition.

As a dispersing agent of pigment, it is preferable to employ one having a basic anchoring site, and further preferably to employ a polymer dispersing agent having a comb-like structure.

Specific examples of dispersing agent of pigment employable in this invention include Solsperse 9000, 17000, 18000, 19000, 20000, 24000SC, 24000GR, 28000, and 32000 (all produced by Avecia Ltd.); Ajisper PB821 and PB822 (both produced by Ajinomoto-Fine Techno Co., Inc.); PLAAD ED214 and ED251, and DISPARLON DA-325, and DA-234 (all produced by Kusumoto Chemicals, Ltd.); and EFKA-5207, 5244, 6220, and 6225 (all produced by EFKA Additives.). Further, a pigment derivative (being a synergist) may be employed in combinations with a dispersing agent of the pigment. Specific examples of pigment derivatives include Solsperse 5000, 12000, and 22000 (all produced by Avecia Ltd.); and EFKA-6747 and -6750 (produced by EFKA Additives.).

Various additives other than the above-described ones may be employed in the active ray curable ink-jet ink composition of this invention. For example, added may be a surface active agent; a leveling additives; a matting agent; and a polyester type resin, a polyurethane type resin, a vinyl type resin, an acryl type resin, rubber type resin, and a wax to adjust physical film properties. Further, to enhance storage stability, any of well-known basic compounds may be employed, and listed as typical ones are a basic alkali metal compound, a basic alkali earth metal compound, and a basic organic compound such as amine. Further, it is possible to make a radical-cationic hybrid type curable ink.

A basic compound may be added to the ink composition. By containing a basic compound in the ink composition, not only ejection stability is enhanced, but also generation of wrinkles by shrinking at curing is restrained even under the low humidity conditions. Any of basic compounds well known in the art may be employed, but listed as typical ones are a basic alkali metal compound, a basic alkali earth metal compound, and a basic organic compound such as amine.

Listed as the above basic alkali metal compound may be an alkali metal hydroxide (such as lithium hydroxide, sodium hydroxide, and potassium hydroxide); an alkali metal carbonate (such as lithium carbonate, sodium carbonate, and potassium carbonate); an alkali metal alcoholate (such as sodium methoxide, sodium ethoxide, potassium methoxide, and potassium ethoxide). Listed as the above basic alkali earth metal compounds may be similarly an alkali earth metal hydroxide (such as magnesium hydroxide, and calcium hydroxide); an alkali earth metal carbonate (such as magnesium carbonate, and calcium carbonate); and an alkali earth metal alcoholate (such as magnesium methoxide).

As basic organic compounds, listed are nitrogen-containing heterocyclic compounds such as amine, quinoline, and quinolizine, and of these, amine is preferable from the viewpoint of compatibility with a photopolymerizable monomer. Listed are, for example, octylamine, naphthylamine, xylene-diamine, dibenzylamine, diphenylamine, dibutylamine, dioctylamine, dimethylaniline, quinuclidine, tributylamine, trioctylamine, tetramethylethylenediamine, tetra-methyl-1,6-hexamethylenediamine, hexamethylenetetramine, and triethanolamine.

As for the concentration at the time of making a basic compound exist, it is 10-1,000 weight ppm based on the total weight of the photopolymerizable compound, and specifically in the range of 20-500 weight ppm. In addition, a basic compound may be used independently, or may be employed in combinations of plural kinds.

In the active ray curable ink-jet ink composition of this invention, viscosity of the ink-jet ink composition at 25° C. is preferably 7-50 mPa·s, in order to obtain stable ejection and good curability irrespective of curing environment (such as temperature and humidity).

As a recording medium utilizable in this invention, various types of non-absorptive plastic and film thereof used in so called light packaging in addition to ordinary non-coated paper and coated paper recording media may be employed, and various plastic films include, for example, PET film, OSP film, OPP film, ONy film, PVC film, PE film, and TAC film. As other plastics, polycarbonate, an acrylic resin, ABS, polyacetal, PVA, and rubbers may be employed. Further, metals and glasses are also applicable.

In this invention, it is advantageous to employ a long length roll (being a web form) recording medium with respect to a cost of a recording medium such as packaging expense and a manufacturing cost, efficiency of print preparation, in addition to adaptability to various types of print sizes.

Next, a method for image forming of this invention will be described.

In a method for forming an image of this invention, preferred is a method of ejecting the above ink onto a recording medium with an ink-jet recording method to form an image, and after that irradiating active rays such as ultraviolet rays to cure the ink.

### Total Ink Layer Thickness after Ink Deposition

In this invention, the total ink layer thickness, after ink has been deposited on a recording medium followed by curing by irradiation of actinic rays, is preferably 2-25 μm. In active ray curable type ink-jet recording in a screen printing field, the total ink layer thickness is exceeding 25 μm under the present situation, however, in an application to light package printing, in which a recording medium is usually comprised of a thin plastic film material, ink ejection of an excess layer thickness is undesirable because, in addition to the above-described problems of curl and wrinkle of a recording medium, a problem of change of stiffness and quality feeling of the total printed matter is caused.

Herein, “the total ink layer thickness” means the maximum value of a layer thickness of ink having been ejected on a recording medium, and the meaning of the total ink layer thickness is the same in any recording of a single color, two-color accumulation (being a secondary color), three-color accumulation or four-color accumulation (being a white ink base).

### Ink Ejecting Condition

As ink ejection conditions, from the viewpoint of ejection stability, it is preferable that a recording head and the ink are heated to 35-100° C. and then the ink is ejected. An active ray curable ink-jet ink composition exhibits large viscosity range with temperature variation, and the viscosity variation greatly affects directly to an ink droplet size and ink ejection rate, resulting in image deterioration. Therefore, it is necessary to raise an ink temperature and to maintain the temperature constant. The control range of ink temperature is (present temperature) ±5° C., preferably (present temperature) ±2° C., and more preferably (present temperature) ±1° C. Further, in this invention, an ink droplet volume ejected from each nozzle is preferably 2-15 pl.

### Light Irradiation Conditions after Ink Deposition

In a method for image forming of this invention, as a irradiation condition of active rays, active rays are preferably irradiated at 0.001-2.0 seconds after ink deposition, and more preferably at 0.001-1.0 second. To form a high definition image, it is important to make irradiation timing of as early as possible.

In an ink-jet recording method of this invention, light irradiation is conducted after the ink composition is adhered onto a recording medium. Light irradiation may be visible light irradiation or ultraviolet ray irradiation, and specifically ultraviolet ray irradiation is preferred. In the case of ultraviolet ray irradiation, an irradiation level of ultraviolet rays is in the range of 100 mJ/cm² or more, and preferably 500 mJ/cm² or more, and further 10,000 mJ/cm² or less, and more preferably 5,000 mJ/cm² or less. Within such a range of an ultraviolet ray irradiation level, it is beneficial because a curing reaction is sufficiently completed, and further, fading of a coloring agent can be redused. As an ultraviolet irradiation lamp, listed are a metal halide lamp, a xenon lamp, a carbon-arc lamp, a chemical lamp, a low pressure mercury lamp, and a high pressure mercury lamp. A commercially available lamp may be employed, for example, an H lamp, a D lamp, and a V lamp, which are produced by Fusion UV Systems, Inc.

Compared to a high pressure mercury lamp (having a main wavelength of 365 nm), a spectrum of a metal halide lamp is continuous, and luminous efficiency of the lamp is high in the range of 200-450 nm, and further, luminous energy in long wavelength areas is abundant. Accordingly, in cases when a pigment is employed as the active ray curable type composition of this invention does, a metal halide lamp is suitable.

Regarding a irradiation method of active rays, a basic way is disclosed in JP-A 60-132767. According to this disclosure, a light source is provided on both side of a head unit, and a head and a light source are scanned with a shuttle method. Irradiation is conducted after a certain period of time after ink deposition. Further, curing is completed with another light source without driving. In U.S. Pat. No. 6,145,979, as a irradiation method, disclosed are a method employing fiber optics, and a method irradiating UV light on a recording area by collimated light reflected at mirror surface provided on a side surface of a head unit. In the method for image forming of this invention, any of these irradiation methods may be employed.

Further, another preferable embodiment is a method in which irradiation of active rays is divided into two steps and active rays are emitted for 0.001-2.0 seconds after ink deposition as the first step, and active rays are further emitted after finishing the whole sheet of printing. By dividing active ray emission into two steps, it restrains further shrinkage of the recording medium, which shrinkage is caused at the time of ink curing.

Heretofore, in a UV ink-jet method, a light source exhibiting high illuminance such as a total electrical consumption of over 1 kW·hr is generally employed to restrain spreading and bleeding of ink dots after deposition. However, when such a light source is employed, particularly in printing on such as shrink label media, at present shrinkage of the recording media is too great to make the product practical.

In this invention, active rays exhibiting the maximum illuminance at a wavelength region of 254 nm is preferably employed so that a high definition image can be formed as well as keeping shrinkage of the recording media is practically within an allowable level even when a light source of a total electrical consumption of over 1 kW·hr is employed.

In this invention, it is further preferable that the total electrical consumption of the light source to emit active rays is less than 1 kW·hr. Examples of light sources of a total electrical consumption of less than 1 kW·hr include, for example, fluorescent tubes, cold cathode tubes and LEDs, however, the light sources are not limited thereto.

The nozzle surface of the recording head employed in typical ink-jet recording apparatus are selected from various materials in accordance with ink characteristics so as to control ink ejection stability, wettability of the ink, and ink durability. For the active ray curable ink-jet ink composition of this invention, various well known materials for the nozzle surface may be employed, for example, a plastic such as polyamide and polysulfone, and a metal such as stainless steel, nickel and gold, however, a metal is extremely preferable for the nozzle material, to maintain ejection stability and wettability of the active ray curable ink-jet ink of this invention.

Subsequently, the ink-jet recording apparatus of this invention (hereinafter, simply referred as to the recording apparatus) will now be described.

In the following, the recording apparatus of this invention will be explained with reference to drawings. Herein, the recording apparatus of the drawings is only one embodiment of a recording apparatus of this invention and a recording apparatus of this invention is not limited to these drawings.

FIG. 1 is a front view showing the relationship of the chief parts and sub-systems of the recording apparatus of this invention. Recording Apparatus 1 is constituted of with Head Carriage 2, Recording Head 3, Irradiation Means 4 and Platen Portion 5. In this Recording Apparatus 1, Platen Portion 5 is arranged under Recording Material P. Platen Portion 5 functions to absorb ultraviolet rays so as to absorb excess ultraviolet rays having passed through Recording Material P. As a result, high definition and very stable images can be reproduced.

Recording Material P is guided by Guide Member 6 to be shifted from the front side toward the interior of FIG. 1 by work of a transport means (not shown in the figure). A head scanning means (also not shown in the figure) performs scanning via Recording Head 3 integrated with Head Carriage 2, by shifting Head Carriage 2 back and forth along the Y direction of FIG. 1.

Head Carriage 2 is mounted above Recording Material P and incorporates plural Recording Heads 3, which will be described later, corresponding to the number of colors utilized for image printing on Recording Material P, so as to direct the ejection outlet downward. Head Carriage 2 is arranged within the main body of Recording Apparatus 1 in a way as to be freely reciprocal in the Y direction in FIG. 1, and reciprocates in the Y direction of FIG. 1 by drive of the head scanning means.

Herein, in FIG. 1, Head Carriage 2 is shown to integrate Recording Head 3 containing yellow (Y), magenta (M), cyan (C), black (K), light yellow (Ly), light magenta (Lm), light cyan (Lc) and light black (Lk), however, the number of colors incorporated in Head Carriage 2 is determined as a practical matter.

Recording Head 3 ejects active ray curable ink (such as UV curable ink), which is supplied from an ink supplying means (not shown in the figure), toward Recording Material P through an ejection outlet by work of a plural number of ejection means (not shown in the figure), which are provided in the interior of Recording Head 3. UV ink ejected by Recording Head 3 is comprised of such as a colorant, a polymerizable monomer and an initiator, and has the characteristic of being cured by a cross-linking and polymerization reaction of the monomer accompanied by the catalitic action of an initiator as a result of emission of UV rays.

Recording Heads 3 eject UV ink as ink drops over a predetermined area (being the area on which ink is to be deposited) of Recording Material P during scanning, whereby Recording Head 3 is shifted from one edge of Recording Material P to the other along the Y direction of FIG. 1, being driven by the head scanning means, whereby ink drops are deposited within said deposition area.

After appropriate repetitions of the above-described scanning to eject UV ink toward the ink deposition area, Recording Material P is appropriately shifted from the front toward the interior of FIG. 1 by a transfer means, and the UV ink is ejected onto the next deposition area, adjacent along the interior of FIG. 1 while performing scanning again by a head scanning means.

By repeating the above scanning operation, coupled with the head scanning means and the recording medium transport means, the UV ink is ejected from Recording Heads 3 onto Recording Material P to form an uncured image.

Irradiation Means 4 is constituted of an ultraviolet lamp which emits ultraviolet rays of a specific wavelength range of stable exposure energy, and a filter which passes ultraviolet rays of a specific wavelength. Herein, as an ultraviolet lamp, such as a mercury lamp, a metal halide lamp, an excimer laser, an ultraviolet laser, a cold cathode tube, a hot cathode tube, a black light and an LED (being a light emitting diode) are applicable, and a metal halide lamp, a cold cathode tube, a hot cathode tube, a mercury lamp or a black light, all of which have a band form, are preferable. In particular, a low pressure mercury lamp, a hot cathode tube, a cold cathode tube and a sterilizing lamp, which emit ultraviolet rays having a wavelength of 254 nm, are more preferable due to reduced bleeding and greater control of the dot diameter. By employing a black light as a radiation source for Irradiation Means 4, UV ink can be cured at low cost.

Irradiation Means 4 is capable of covering the same area as the maximum which can be set in Recording Apparatus 1 (being an UV ink-jet printer), or an area not smaller than an area, within which ink can be deposited in one scan by the drive mechanism of the head scanning means.

Irradiation Means 4 is fixed on both sides of Head Carriage 2, approximately parallel to Recording Material P.

As described above, as a means to adjust the illuminance level onto the ink ejection portion, in addition that entire Recording Head 3 is inherently light shielded, it is effective to make distance h2 between Ink Ejection Outlet 31 of Recording Head 3 and Recording Material P larger than distance h1 between Irradiation Means 4 and Recording Material P (h1<h2), or to make a distance d between Recording Head 3 and Irradiation Means 4 apart (to make d larger). Further, it is more preferable to fit Bellows Structure 7 between Recording Head 3 and Irradiation Means 4.

Herein, wavelength of ultraviolet rays irradiated by Irradiation Means 4 may be appropriately changed by converting an ultraviolet lamp or a filter, both of which are arranged in Irradiation Means 4.

The active ray curable ink-jet ink composition of this invention is employed to form an image with a line head type recording apparatus.

FIG. 2 is a top view showing an example of the other constitution of the chief parts of the ink-jet recording apparatus. The ink-jet recording apparatus shown in FIG. 2 is known as a line head type, and a plural number of Recording Heads 3 of each color are arranged by being fixed onto Head Carriage 2 so as to enable coverage of the entire width of Recording Material P.

On the other hand, downstream of Head Carriage 2, Irradiation Means 4 is arranged so as to similarly cover the whole width of Recording Material P.

### [Add-5]

FIG. 3 shows the nozzle surface of the ink-jet recording head comprising the ink-jet recording apparatus of this invention. The material of Nozzle Surface 32 of Recording Head 3 is preferably a metal as described previously.

In a line head type recording apparatus, Head Carriage 2 and Irradiation Means 4 are fixed, and only Recording Material P is transported, and then ejection and curing of the ink are performed to form an image.

### EXAMPLE

In the following, the present invention will be specifically explained with reference to examples, however, it is not limited thereto.

### Example 1

### [Preparation of Active Ray Curable Ink-Jet Ink Composition]

An Active ray curable ink-jet ink Composition was prepared by addition and dissolution of a polymerizable compound, a photopolymerization initiator, and a silicone oil as described in following Table 1.

TABLE 1

| Active Ray | | | | | | | | | | |
|---|---|---|---|---|---|---|---|---|---|---|
| Curable Type | | Cationic Polymerizable Compound | | | | | | Radical | | |
| Ink-jet Ink | | Compound having an | | | | | | Polymerizable | | |
| Composition | Pigment | oxetane ring | | | Epoxy compound | | Other | Compound | | |
| No. | P1 | OXT221 | OXT101 | OXT212 | CEL2021P | EP-17 | DEV-3 | DPGDA | TMPTA | HEMA |
| 1 | 5 | 55 | 5 | 12.4 | 20 | | | | | |
| 2 | 5 | 55 | 5 | 12.4 | | 20 | | | | |
| 3 | 5 | 55 | 5 | 12.4 | | 15 | 5 | | | |
| 4 | 5 | 55 | 5 | 12.4 | 20 | | | | | |
| 5 | 5 | 55 | 5 | 12.4 | | 20 | | | | |
| 6 | 5 | 55 | 5 | 12.4 | | 15 | 5 | | | |
| 7 | 5 | 55 | 5 | 12.4 | 20 | | | | | |
| 8 | 5 | | | | | | | 42.4 | 30 | 20 |
| 9 | 5 | | | | | | | 42.4 | 30 | 20 |
| 10 | 5 | 55 | 5 | 12.4 | | 20 | | | | |
| 11 | 5 | | | | | | | 42.4 | 30 | 20 |
| 12 | 5 | | | | | | | 42.4 | 30 | 20 |

| | | | | |
|---|---|---|---|---|
| Active Ray | | | | |
| Curable Type | Cationic Photo- | Radical Photo- | Silicone Oil | Polyether |
| Ink-jet Ink | polymerization | polymerization | of this | modified |
| Composition | Initiator | Initiator | Invention | Silicone Oil |

| No. | UV16992 | S-1 | IRG369 | A | B | C | D | E | F | Remarks |
|---|---|---|---|---|---|---|---|---|---|---|
| 1 | 2.5 | | | 0.1 | | | | | | This invention |
| 2 | 2.5 | | | | 0.1 | | | | | This invention |
| 3 | 2.5 | | | | | 0.1 | | | | This invention |
| 4 | | 2.5 | | 0.1 | | | | | | This invention |
| 5 | | 2.5 | | | 0.1 | | | | | This invention |
| 6 | | 2.5 | | | | 0.1 | | | | This invention |
| 7 | 2.5 | | | | | | 0.1 | | | Comparative |
| | | | | | | | | | | example |
| 8 | | | 2.5 | | | | | 0.1 | | Comparative |
| | | | | | | | | | | example |
| 9 | | | 2.5 | 0.1 | | | | | | Comparative |
| | | | | | | | | | | example |
| 10 | | 2.5 | | | | | | 0.1 | | Comparative |
| | | | | | | | | | | example |
| 11 | | | 2.5 | | | | | | 0.1 | Comparative |
| | | | | | | | | | | example |
| 12 | | | 2.5 | | 0.1 | | | | | Comparative |
| | | | | | | | | | | example |

Footnote #1)
Viscosity of each Active Ray Curable Type Ink-jet Ink Composition is 28–32 mPa · s (at 25° C.)
Footnote #2)
Surface tension of each Active Ray Curable Type Ink-jet Ink Composition is 26–31 mN/m (at 25° C.)

Compounds employed in the table are as follows:

P1: Fed into a one gallon steel kneader (manufactured by Inoue Mfg., Inc.), were 250 parts of crude copper phthalocyanine (namely “Copper Phthalocyanine”, produced by Toyo Ink Mfg. Co., Ltd.), 2,500 parts of sodium chloride, and 160 parts of polyethylene glycol (namely “Polyethylene Glycol 300”, produced by Tokyo Chemical Industry Co., Ltd.), after which the mixture was kneaded for three hours. Subsequently, to make a slirry state, the mixture was poured into 2.5 L of warm water, and heated to about 80° C. while stirring for about one hour with a high speed mixer. After that, filtration and washing were repeated for five times to remove all sodium chloride and any solvent, and then dried with a spray drying process.
OXT221: Compound having an oxetane ring (produced by Toagosei Co., Ltd.)
OXT101: Compound having a oxetane ring (produced by Toagosei Co., Ltd.)
OXT213: Compound having a oxetane ring (produced by Toagosei Co., Ltd.)
CEL2021P: Epoxy compound (produced by Daicel Chemical Industries, Ltd.)
EP-17: Epoxy compound (Please refer to the formula of exemplified compounds.)
DVE-3: Vinyl ether compound (produced by ISP)
DPGDA: Dipropylene glycol diacrylate
TMPTA: Trimethylolpropane triacrylate
HEMA: Hydroxyethyl methacrylate
UV16992: Cationic photopolymerization initiator of 50% propioncarbonate solution (produced by The Dow Chemical Company)
S-8: Cationic photopolymerization initiator (please refer to the formula of exemplified compounds.)
IRG369: Radical photopolymerization initiator (produced by Ciba Specialty Chemicals)
Silicone Oil
   A: Alkyl modified silicone oil (EFKA3236, produced by EFKA Additives)
   B: Alkyl aralkyl modified silicone oil (KF410, produced by Shin-Etsu Chemical Co., Ltd.)
   C: Alkyl modified silicone oil (SH203, produced by Dow Corning Toray Silicone Co., Ltd.)
   D: Polyether modified silicone oil (DC57Additive, produced by Dow Corning Corporation)
   E: Polyether modified silicone oil (KF352, produced by Shin-Etsu Chemical Co., Ltd.)
   F: Polyether modified silicone oil (KF945, produced by Shin-Etsu Chemical Co., Ltd.)

Viscosity was measured with a Physica MCR (Modular Compact Rheometer) 300, manufactured by Anton Paar GmbH, at 25° C. and a shear rate of 1,000. While, surface tension was measured with Surface Tensiometer CBVP-3A, (manufactured by Kyowa Interface Science Co., Ltd.), using a platinum plate.

### Method for Ink-Jet Image Formation

Each ink composition was loaded into an ink-jet recording apparatus consisted of the constitution shown in FIG. 1, which apparatus was provided with a piezo type ink-jet nozzle, which surface was made of stainless steel. Then, the following image recording was continuously conducted onto a long roll of PET (polyethylene terephthalate) of 600 mm in width and 500 m in length, as described in Table 2. An ink supply system, consisting of ink tanks, supply pipes, a front chamber ink tank just before the head, piping with filters, and a piezo head, in which a portion from the front chamber to the head was heat insulated and heated to 50° C. The piezo head was driven so as to enable ejection dots of 50 pl, and each ink was continuously ejected. After ink deposition, each ink was immediately cured (being less than two seconds after ink deposition) with lamp units on both sides of the carriage. Each of the following evaluations was conducted under conditions of 10° C. and 20% RH, 25° C. and 50% RH, and 28° C. and 80% RH, after image recording of the above method.

### Evaluation of Ink-Jet Recorded Image

Each image recorded with the method for forming an image as described above was evaluated for each of the following items.

### Character Quality

Six point Ming-type characters were printed with the aim for ink density, edges of characters were magnified with a loupe, and character quality was evaluated based on the following criteria.
A: No rough edge was noted.
B: Slight rough edges were slightly noted.
C: Rough edges were noted, but characters were readable and within the limit of commercial viability.
D: Rough edges were severe, and adjacent characters touched slightly, and were not commercial viability.

### Image Wrinkling

Printing was conducted so that dots were overlapped each other and the produced solid image was magnified and any evidence of image wrinkling was visually evaluated based on the following criteria.
A: Dot shapes overlapping each other were not noted, and a uniform solid image was formed.
B: Dot shapes overlapping each other were slightly noted, but a nearly uniform solid image was formed.
C: Dot shapes overlapped each other, and a patterned surface solid image was formed but, it was uniform.
D: Dot shapes overlapped each other, and a nonuniform patterned and ragged solid image was formed.

### Staining

Within 10 minutes after ink deposition, a non-image portion of the printed image was modified with a loupe to visually observe ink staining for evaluation of staining based on the following criteria.
A: No staining was noted.
B: Slight staining was noted, but was commercially viable.
C: Partial staining of questionable commercially viability was noted.
D: Staining was noted over nearly the whole area, and was not commercially viable.

The results obtained from the above evaluations are shown in Table 2.

TABLE 2

| Active ray | | | | |
|---|---|---|---|---|
| curable type | | | | |
| ink-jet ink | Character | Image | | |
| composition No. | quality | wrinkle | Staining | Remarks |
| 1 | A | A | A | This invention |
| 2 | A | A | A | This invention |
| 3 | A | A | A | This invention |
| 4 | A | A | A | This invention |
| 5 | A | A | A | This invention |
| 6 | A | A | A | This invention |
| 7 | B | C | C | Comparative |
| | | | | example |
| 8 | C | D | D | Comparative |
| | | | | example |
| 9 | C | C | D | Comparative |
| | | | | example |
| 10 | B | C | C | Comparative |
| | | | | example |
| 11 | C | D | D | Comparative |
| | | | | example |
| 12 | C | C | D | Comparative |
| | | | | example |

From the results of Table 2, it is clear that the samples of the present invention are superior in ejectability, and exhibit no image deterioration with dot spreading, and further exhibit excellent performance in the tested operating conditions.

Further, similar results as above were obtained when Yupo FGS (being a trade name, produced by Yupo Corp.) and PVC (polyvinyl chloride) were employed as a recording material instead of PET.

What is claimed is:

1. An active ray curable ink-jet ink composition comprising:
(a) a cationic polymerizable compound,
(b) a cationic photopolymerization initiator, and
(c) an alkyl modified or an alkyl aralkyl modified silicone oil.

2. The active ray curable ink-jet ink composition of claim 1, wherein the cationic polymerizable compound is
(i) a compound having an oxetane ring; or
(ii) an epoxy compound.

3. The active ray curable ink-jet ink composition of claim 1, an amount of the alkyl modified or the alkyl aralkyl modified silicone oil is from 0.001 to 10 weight % based on the total weight of the ink-jet ink composition.

4. The active ray curable ink-jet ink composition of claim 1, further comprising at least one pigment.

5. The active ray curable ink-jet ink composition of claim 1, wherein a surface tension of the ink-jet ink composition at 25° C. is 25-35 mN/m.

6. The active ray curable ink-jet ink composition of claim 1, wherein the ink-jet ink composition has a viscosity of 7-50 mPa·s.

7. A method for forming an image comprising the steps of:
(a) ejecting an active ray curable ink-jet ink composition of claim 1 onto a recording material, and
(b) irradiating active rays onto the ejected ink-jet ink composition to form an image,
wherein the active rays are irradiated during 0.001-2.0 sec. after the active ray curable ink-jet ink composition is deposited.

8. An ink-jet recording apparatus employed for the method of claim 7, wherein an active ray curable ink-jet ink composition is ejected from a recording head after the active ray curable ink-jet ink composition and the recording head are heated to 35-100° C.

9. The ink-jet recording apparatus employed for the method of claim 8, wherein a nozzle surface of the recording head from which the active ray curable ink-jet ink composition is ejected is made of metal.
